(19) United States
(12) Patent Application Publication
(10) Pub. No.: US 2008/0149194 A1
(43) Pub. Date: Jun. 26, 2008

(54) Automatic annular valve

(76) Inventors: Bernhard Spiegl, Wien (AT); Markus Testori, Hollabrunn (AT); Peter Steinruck, Hallstatt (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/000,457

(22) Filed: Dec. 12, 2007

(30) Foreign Application Priority Data
Dec. 22, 2006 (AT) A 2127/2006

(51) Int. Cl. F16K 15/08; B21K 5/20

(52) U.S. Cl. 137/516.21; 137/511; 29/890.128

(57) ABSTRACT

Simple refinishing of the valve seat 3 of an annular valve 1 is made possible, which has a plurality of ring guide studs 15 arranged radially and separated in circumferential direction and projecting from said valve seat 3 to guide sealing rings 5 in radial and axial direction, whereby a recess 18 is provided in the valve seat 3 extending in circumferential direction between to ring guide studs 15 lying at the same radius. No cross piece negatively influencing the outgoing flow must remain between the sealing surfaces 17 in the area of the recess 18 during refinishing of said sealing surfaces 17 of the valve seat 3.

### BACKGROUND OF THE INVENTION

1. Field of the Invention

The present invention relates to an automatic annular valve including a valve seat, a valve guard, and a number of reciprocatingly arranged concentric sealing rings arranged between the valve seat and the valve guard, whereby the sealing rings sealingly cooperate with the valve seat, and including further a plurality of ring guide studs extending axially from the valve seat while being distributed radially and in circumferential direction, whereby, the ring guide studs (15) serve to guide the sealing rings in radial and axial direction as well as a method for the production and refinishing of the valve seat of the automatic annular valve.

2. The Prior Art

In case of annular valves, especially for sealing purposes, the valve element can be designed having a valve plate provided with either a row of annular openings or a plurality of separate concentric sealing rings. In the use of concentric sealing rings it is already known in the art to use additionally a synchronizing plate which rests against the sealing rings and is moved in conjunction with said rings to synchronize and dampen the movement of the individual sealing rings. The sealing rings and the synchronizing plate form thereby together the valve element whereby the sealing rings and the synchronizing plate are, however, placed only loosely against one another. The damping effect of the synchronizing plate is the result of the own weight of the synchronizing plate, on the one hand, or the synchronizing plate can also be biased by a spring, on the other hand. The design comprising a synchronizing plate offers additionally the advantage that large and robust springs can be selected which can be affixed at the center of the synchronizing plate consisting of radial bridges and openings extending in circumferential direction. For example, an annular valve of this type is disclosed in AT 391 928 B or EP 345 245 A2. An auxiliary damping plate may still be provided in the annular valve as shown in EP 345 245 A2 as well. However, such a damping plate acts independently from the sealing element and is arranged at a distance from the sealing element and it serves only to further dampen the movement of the ring opening essentially through its own weight after a specific opening distance of the valve.

However, the use of a synchronizing plate has the disadvantage that the traditional guide elements at the sides of the guards would have to project through the synchronizing plate to ensure guidance of the rings as it is know in the art from older annular valves. On the one hand, the guide elements projecting through the synchronizing plate would weaken the synchronizing plate, and, on the other hand, the guide elements would lead also to a significant negative influence on the flow diameter and would thereby negatively influence the efficiency of the valve. Such a negative influence is not acceptable, especially in the case of high capacity valves. At the same token, highly stressed valves require a considerably better and more precise ring guidance since otherwise this could lead to unacceptable transverse movements of the sealing rings and consequently increased wear, which is to be avoided. This problem is avoided through specific positioning of the ring guide studs on the valve seat, as it is also disclosed in older valve designs. However, the specific positioning of the ring guides on the valve seats leads to considerable problems in maintenance and overhauling of the annular valves during refinishing of the valve seat in repair shops since the surfaces between the ring guides can be refinished only by extensive milling work and not only by simple turning. As a rule, the surfaces would have to be worked as well during refinishing of the sealing surfaces, e.g. cutting of the sealing surfaces—whereby, above all, corresponding compensation in valve lift is not possible since the cross piece remaining between the sealing surfaces could negatively influence the outgoing flow of gaseous medium. In case of valve lifts in the millimeter range there are already very narrow valve gaps between the sealing ring and the sealing surface on the valve seat which make the flow through the valve very susceptible to failure. Due to the necessary extensive refinishing work such valves were not employed heretofore even in spite of their possible advantages.

It is therefore the object of the present invention to further develop an annular valve of the aforementioned type in such a manner that the valve seat of such an annular valve can be refinished in a very simple manner during the course of maintenance and overhauling while being safe for the functioning of the annular valve.

### SUMMARY OF THE INVENTION

This object is achieved according to the invention in that a recess extending in circumferential direction is provided in the valve seat between two ring guide studs lying on the same radius. Through the recesses it is ensured that no cross piece remains between two adjacent sealing surfaces, at least in the area of the recesses, during refinishing of the sealing surface, e.g. by means of turning, so that the outgoing flow is not negatively influenced. Such a recess makes very simple refinishing possible thereby since extensive milling work is no longer required between the ring guide studs. The valve seat can be refinished in a simple manner only through this process and an annular valve of this type can be economically employed as a result thereof.

The recess in circumferential direction between two adjacent ring guide studs is preferably continuous since no cross piece is to remain in any area between the ring guide studs, which is advantageous for the outgoing flow. It is also preferably proposed that the recesses extend continuously in radial direction between two adjacent sealing surfaces of the valve seat.

Refinishing of the sealing surfaces can be simplified if an undercut section is provided at a ring guide stud in the region of the transition to the valve seat.

The present invention is described in the following with the aid of the non-limiting drawings.

### BRIEF DESCRIPTION OF THE DRAWINGS

FIG. 1 shows a section through an annular valve according to the invention;

FIG. 2 shows an exploded view of the annular valve;

FIG. 3 shows a detailed illustration of the valve seat; and

FIG. 4 shows a partial section of the valve seat in an enlarged illustration.

### DETAILED DESCRIPTION OF THE PREFERRED EMBODIMENT

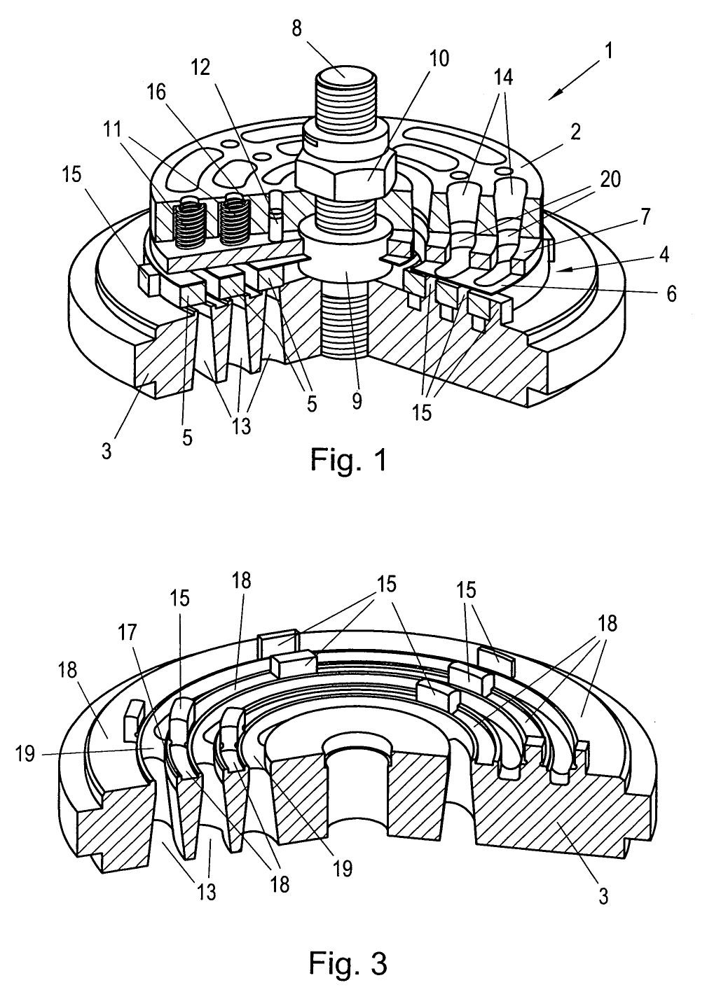

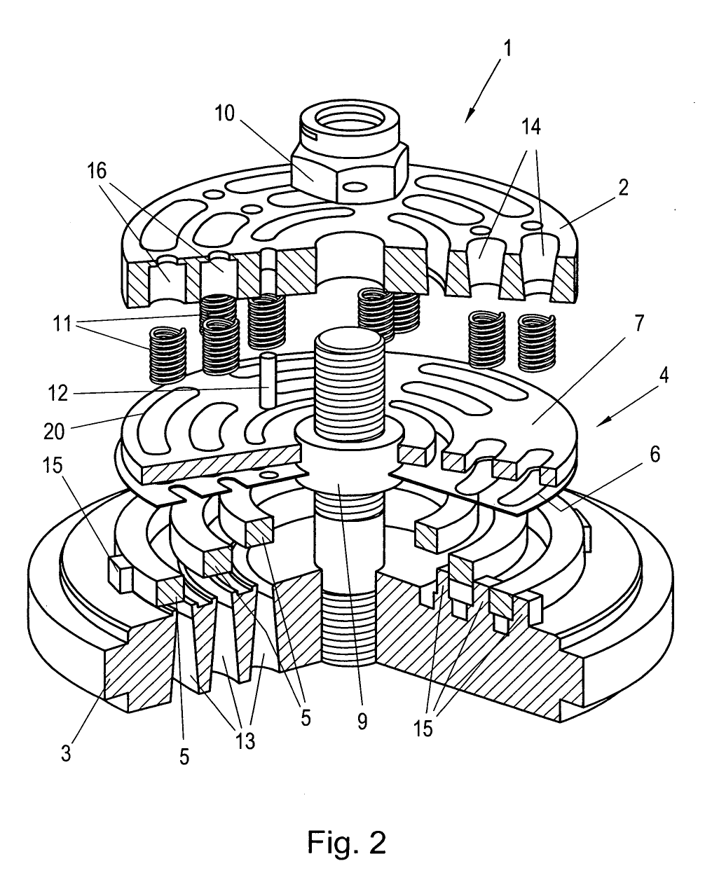

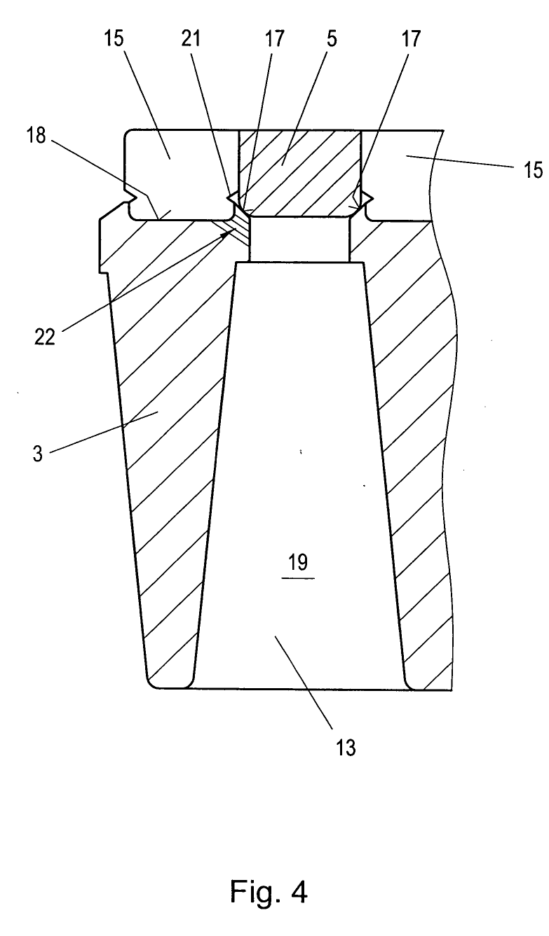

The basic design of an annular valve 1 is known in the art heretofore and for this reason it is only briefly discussed by referring to FIG. 1 and FIG. 2. An annular valve 1 for employment in compressors consists of a valve seat 3 and a valve guard 2. A valve element 4 is arranged between the same, which is moved back and forth between the valve seat 3 and the valve guard 2, and which takes on the sealing function in cooperation with the valve seat 3 whereby it closes and opens the flow diameter through the annual valve 1. The individual parts of the annular valve 1 are held together by means of a through-going bolt 8 and a nut 10. The space between the valve seat 3 and the valve guard 2, and thereby the possible valve lift, is adjusted through a spacer disk 9 or an axial projection on the valve guard 3 of on the valve seat 3. Annular through-passages 13 are arranged in the valve seat 3 and annular outlet passages 14 are arranged in the valve guard 2. The annular passages 13, 14 are actually semi-circular sections as generally known in the art, which are divided by radial cross pieces 19 (as it can be better viewed in FIG. 3 and FIG. 4).

The valve element 4 encompasses concentrically arranged sealing rings 5 which cooperate with the valve seat 3. Moreover, associated and cooperating sealing surfaces 17 are respectively arranged on the sealing rings 5 and on the valve seat 3. The sealing surfaces 17 on the sealing rings 5 can be flat, for example (which means they can lie at a normal plane to the axis of the annual valve 1); however, the sealing rings 7 could also be provided with tapered edges serving as sealing surfaces 17, as shown in FIG. 3 and FIG. 4, for example—or the sealing rings 5 could also have toroidal sealing surfaces. Any sealing surfaces formed otherwise are still possible in principle. In any case, all correspondingly arranged sealing surfaces 17 on the valve seat 3 are shaped to match each other.

A plurality of guide studs 14 projecting axially from the valve seat 3 in the direction of the sealing rings 5 are arranged on the valve seat 3 whereby said guide studs are distributed along the circumference of said valve seat at varying radial distances to one another, and whereby the individual sealing rings 5 are arranged between said ring guide studs in radial and in axial direction. The ring guide studs 15 project thereby axially from the valve seat 3 at least to such a degree that the sealing rings 5 remain in place during the entire opening movement of the ring. A ring guide stud 15 is thereby arranged in radial direction between two sealing surfaces 17 of the valve seat 3.

The valve element 4 may furthermore comprise a synchronizing plate 7, which is arranged on the sides of the sealing rings 5 facing away from the valve seat 3, and a separating plate 6 lying between the synchronizing plate 7 and the sealing rings 5. The synchronizing plate 7 is biased by a row of helical springs 11 arranged in spring pockets 16 in the valve guard 2. The helical springs 11 press thereby the sealing rings 5 against the valve seat 3 with the synchronizing plate 7. The sealing rings 5 are lifted away from the valve seat 3 through the existing gas pressure acting against the force of the helical springs 11 during the opening movement of the rings. Flat springs could also be provided as known in the art in place of the helical springs 11—or spring action could be achieved through resilient arms bent away from the synchronizing plate 7. The synchronizing plate 7, the separating plate 6 and the sealing rings 5 form the valve element of the annular valve 1—they are lying loosely against one another and are moved in unison.

Of course, a number of preferably annular flow passages 20 are arranged in the synchronizing plate 7 and the separating plate 6 (actually a number of semi-circular sections which are separated by radial cross pieces), so that the gaseous medium can pass through the annular valve 1 with the least restriction.

Since the flow openings 20 of the synchronizing plate 7 and of the separating plate 6 remain properly positioned relative to the through-passages 13 of the valve seat and the outlet passages 14 of the valve guard 2 (and the available flow diameter is not reduced), it is prevented thereby that these parts are twisted relative to one another and prevented is also that the through-flow openings 20 and/or the passages 13, 14 are partially covered thereby. A locking pin 12 may be pushed additionally through a corresponding opening in the valve guard 2, the synchronizing plate 7, and the separating plate 6. The synchronizing plate 7 and the separating plate 6 may be moved in radial and axial direction along a component of the annular valve, e.g. the spacer disk 9. Of course, this locking action and guidance can also be established through other possible ways, e.g. by means of corresponding projections or stops on the individual parts, as for example on the separating plate 6.

As illustrated in FIG. 3 and in more detail in FIG. 4, a recess 18 is cut into the valve seat 3 respectively in circumferential direction between two ring guide studs 15, lying at the same radius, and between the sealing surfaces 17 of two adjacent sealing rings 5—or radially outside or radially inside the outermost or innermost radial sealing surface 17—whereby said recess is initially cut during the production of the valve seat 3, for example.

A sealing ring 5 lies against the continuous annular sealing surface 17 on the valve seat 3, which can be tapered, toroidal or have any other desired shape, whereby said sealing ring seals the through passages 13. If the ring guide studs 15 are wider than the recesses 18, or if they have to be wider based on the width of the sealing rings 5, an undercut section 21 may be provided as well at the transition from the ring guide stud 15 to the sealing surface 17 to make refinishing of the sealing surface 17 easier.

The valve seat 3 is basically a rotating body. The area between the ring guide studs 15 cannot be finished by turning but must be accomplished by cutting since the ring guide studs 15 project from the valve seat 3, which is comparatively more complicated. The sealing surface 17 on the valve seat 3 can be turned since the recesses 18 have been cut already in the valve seat 3 without leaving a cross piece on the valve seat 3 between the sealing surfaces and the ring guide studs 15, which would negatively influence the flow, whereby refinishing is made possible in a simple manner. Depending on the depth of the recess 18, preferred are depths of 1 through 5 mm, the valve seat 3 or the sealing surface 17 can be refinished (turned again) even several times, as indicated by the marks 22 in FIG. 4.

In principle, the recess 18 in circumferential direction between the ring guide studs does not have to be continuous if the remaining bridge(s) between the sealing surfaces 17, caused by uneven recesses or uneven refinishing, negatively influence the outgoing flow in the function of the annular valve 1 only negligibly or very slightly. The recess 18 in radial direction would not have to be finished in a continuous manner either—conceivable are two or more concentric recesses—again, if the remaining bridge(s) between the sealing surfaces 17, caused by uneven recesses or uneven refinishing, negatively influence the outgoing flow only negligibly or very slightly. This depends essentially on the use and the dimension of the annular valve 1. However, in the most preferred embodiment there is a continuous recess 18 provided extending radial in circumferential direction between the ring guide studs 15 and the sealing surfaces 17.

At the same token, the recess 18 does not have to be even, as in the example in FIG. 4, but it could have any cross section so that the outgoing flow is not influenced at all or only slightly. It would be conceivable that there is a cross section of the recess 18 that is lower directly adjacent to the sealing surfaces 17 than in the center of the recess 18, e.g. a recess 18 with a convex or concave bottom or a recess 18 in which a pyramidal center piece remains standing.

Under certain circumstances, other parts of the annular valve 1 would have to be refinished, of course, after refinishing the sealing surfaces 17, e.g. the spacer disk 9 or the height of the ring guide studs 15, to maintain functioning of the annular valve 1 and not to alter the predetermined lift of the annular valve 1, in particular.

1. An automatic annular valve comprising a valve seat (3), a valve guard (2), and a number of reciprocatingly arranged concentric sealing rings (5) arranged between the valve seat (3) and the valve guard (2), whereby said sealing rings sealingly cooperate with the valve seat (3), and comprising further a plurality of ring guide studs (15) extending axially from the valve seat (3) while being distributed radially and in circumferential direction, said ring guide studs (15) serve to guide the sealing rings in radial and axial direction, characterized in that a recess (18) extending in circumferential direction is provided in the valve seat (3) between two ring guide studs (15) lying at the same radius.

2. An automatic annular valve according to claim 1, wherein the recess (18) is continuous in circumferential direction between two adjacent ring guide studs (15).

3. An automatic annular valve according to claim 1, wherein the recess (18) is continuous between two adjacent sealing surfaces (17) of the valve seat (3).

4. An automatic annular valve according to claim 1, wherein an undercut section (21) is provided at a ring guide stud (15) in the region of the transition to the valve seat (3).

5. A method for the production a valve seat (3) of an automatic annular valve (1), having a number of ring guide studs (15) extending axially from the valve seat (3) while being distributed radially in circumferential direction serving as guides for sealing rings (5), characterized in that a recess (18) extending in circumferential direction is cut into the valve seat (3) between two ring guide studs (15) lying at the same radius.

6. A production method according to claim 5, whereby a recess (3) extending continuous in circumferential directions is cut between the ring guide studs (15).

7. A production method according to claim 5, whereby a recess (18) extending continuous in circumferential directions is cut between two adjacent sealing surfaces (17) of the valve seat (3).

8. A method for refinishing of the valve seat (3) of an annular valve (1), having a number of ring guide studs (15) extending axially from the valve seat (3) while being distributed radially and in circumferential direction serving as guides for sealing rings, characterized in that a sealing surface (17) of the valve seat (3) is turned whereby said sealing surface is separated from an adjacent sealing surface (17) by a recess (18) extending in circumferential direction and arranged between two adjacent ring guide studs (15).
